(19) United States
(12) Patent Application Publication
(10) Pub. No.: US 2026/0260625 A1
(43) Pub. Date: Sep. 3, 2026

(54) DISPLAY DEVICE

(71) Applicant: LG Display Co., Ltd., Seoul (KR)

(72) Inventor: Sanghwa LEE, Paju-si (KR)

(73) Assignee: LG Display Co., Ltd., Seoul (KR)

(21) Appl. No.: 19/409,349

(22) Filed: Dec. 4, 2025

(30) Foreign Application Priority Data
Feb. 28, 2025 (KR) 10-2025-0026731

(51) Int. Cl. G09G 3/3275

(52) U.S. Cl. CPC G09G 3/3275; G09G 2300/0842; G09G 2310/0291; G09G 2320/041

(57) ABSTRACT

A display device and a driving method of the display device are discussed. The display device can include a data driver configured to generate a sampling voltage and a temperature data, and a timing controller configured to change the bias control signal based on the sampling voltage and the temperature data. The data driver can include an output amplifier unit configured to generate an amp voltage based on the bias control signal and the image data, a sampling unit configured to sample the amp voltage at a preset period and output the sampling voltage, and a temperature sensor configured to measure a temperature of the data driver and generate the temperature data.

### CROSS-REFERENCE TO RELATED APPLICATIONS

This application claims priority to Korean Patent Application No. 10-2025-0026731, filed in the Republic of Korea on February 28, 2025, which is hereby incorporated by reference in its entirety.

### BACKGROUND

### Field of Technology

The present disclosure relates to a display apparatus and particularly to, for example, without limitation, a display device.

### Description of the Related Art

As an information society develops, a demand for a display device for displaying an image is increasing in various forms. Accordingly, various display devices such as a liquid crystal display (LCD), a plasma display panel (PDP), and an organic light emitting display (OLED) have recently been used.

Among the display devices, the organic light emitting display device is a self-luminous type, has better viewing angle and contrast ratio than the liquid crystal display (LCD), and has an advantage of being lightweight and thin because a separate backlight is not required and power consumption is advantageous. In addition, the organic light emitting display device has an advantage of being driven with a low DC voltage, having a fast response speed, and especially low manufacturing cost.

The display device includes a display panel that displays an image, and a data driver that supplies a data voltage to the display panel. In this case, a load of the display panel can vary according to a physical condition of the display panel. For example, the load of the display panel can vary according to a size of the display panel.

The load of the display panel can change and a slew rate of the data driver can change. Specifically, when the data driver supplies the data voltage to the display panel, a speed at which the display panel outputs the image in response to the data voltage can be delayed. Alternatively, the data voltage input to the display panel can be less than a voltage for driving the display panel. Accordingly, the display panel may not be stably driven, and quality of the display panel can be deteriorated.

Alternatively, even if the data voltage is stably supplied to the display panel, a temperature of the data driver may not satisfy a certain condition. In this case, the data driver may not stably drive. In addition, when the display device is an organic light emitting display device, since an organic light emitting diode constituting the organic light emitting display device is vulnerable to deterioration, the display panel may not be stably driven.

To improve this, it is cumbersome to directly check the conditions of the data voltage and the temperature of the data driver by directly measuring a magnitude of the data voltage and the temperature of the data driver suitable for the load of the display panel,

### SUMMARY OF THE DISCLOSURE

The present disclosure has been made in view of the above problems and other limitations associated with the related art.

Accordingly, it is an aspect of the present disclosure to provide a display device capable of automatically setting an output voltage of a data driver and a temperature of a data driver, and a method of driving the same,

In accordance with an aspect of the present disclosure, the above and other technical effects can be accomplished by the provision of a display device comprising a display panel including a plurality of pixels, a data driver configured to supply a data voltage to the display panel and generate a sampling voltage and a temperature data, and a timing controller configured to supply a bias control signal and an image data to the data driver and change the bias control signal based on the sampling voltage and the temperature data, and wherein the data driver includes an output amplifier unit configured to generate an amp voltage (e.g., amplifier voltage or output voltage) based on the bias control signal and the image data, a sampling unit configured to sample the amp voltage at a preset period and output a sampling voltage, and a temperature sensor configured to measure a temperature of the data driver and generate the temperature data.

In addition, in accordance with an aspect of the present disclosure, the above and other technical effects can be accomplished by the provision of a driving method of display device comprising generating an amp voltage through the data driver based on a bias voltage and an analog data signal and sampling the amp voltage, generating a temperature data by measuring a temperature the data driver and/or an area around the data driver at a preset period, determining whether the amp voltage reached a target voltage at a sampling point of the amp voltage, determining whether the temperature data reached a target temperature, and resetting a bias control signal configured to control a magnitude of the bias voltage according to a determination result of the amp voltage and the target voltage and a determination result of the temperature data and the target temperature.

It is to be understood that both the foregoing general description and the following detailed description are examples and explanatory and are intended to provide further explanation of the inventive concepts as claimed

### BRIEF DESCRIPTION OF THE DRAWINGS

The accompanying drawings, which are included to provide a further understanding of the present disclosure and are incorporated in and constitute a part of this application, illustrate embodiments of the present disclosure and together with the description explain the principle of the disclosure. In the drawings:

FIG. 1 is a block diagram of a display device according to one or more embodiments of the present disclosure.

FIG. 2 is an example of a circuit diagram of a pixel in the display device of FIG. 1.

FIG. 3 is an example of a block diagram of a data driver and a timing controller according to an embodiment of the present disclosure.

FIG. 4 is a block diagram of a data drive integrated circuit (IC) according to an embodiment of the present disclosure.

FIG. 5 is a circuit diagram of an output amplifier according to an embodiment of the present disclosure.

FIG. 6 is a flowchart illustrating a driving method of a display device according to an embodiment of the present disclosure.

FIGS. 7 to 10B are examples of the graphs of amp voltage and temperature data according to an embodiment of the present disclosure.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Reference will now be made in detail to embodiments of the present disclosure, examples of which can be illustrated in the accompanying drawings. The progression of processing steps and/or operations described is an example; however, the sequence of steps and/or operations is not limited to that set forth herein and can be changed as is known in the art, with the exception of steps and/or operations necessarily occurring in a particular order. Names of the respective elements used in the following explanations can be selected only for convenience of writing the specification and can be thus different from those used in actual products.

Advantages and features of the present disclosure, and implementation methods thereof, will be clarified through the following examples described with reference to the accompanying drawings. The present disclosure may, however, be embodied in different forms and should not be construed as limited to the examples set forth herein. Rather, these examples are provided so that the specification of the present disclosure will be thorough, complete, and fully convey the scope of the present disclosure to those skilled in the art.

A shape, a size, a ratio, an angle, and a number disclosed in the accompanying drawings for describing the examples of the present disclosure are merely illustrative and, thus, the present disclosure is not limited to the illustrated details. Unless stated otherwise, like reference numerals refer to like elements throughout the specification. In the following description, when the detailed description of the relevant known function or configuration is determined to unnecessarily obscure an important point of the present disclosure, the detailed description will be omitted. In a case where terms such as ‘comprise’, ‘have’, and ‘include’ described in the present disclosure are used, another portion can be added unless ‘only’ is used. The terms of a singular form can include plural forms unless referred to the contrary.

In interpreting the components, it is interpreted as including an error range even if there is no separate explicit description of an error range.

In describing a position relationship, for example, when the position relationship is described using terms such as ‘upon’, ‘above’, ‘below’ and ‘next to’, one or more portions can be disposed between two other portions unless ‘just’ or ‘direct’ is used. The terms, such as “below,” “lower,” “above,” “upper”, and the like, can be used herein to describe a relationship between elements as illustrated in the drawings. It will be understood that the terms are spatially relative and based on the orientation depicted in the drawings.

A description of a time relationship can include a case in which the temporal precedence relationship is described as “after”, “following”, or “before”, etc., and is not continuous unless “right away” or “directly”, is used.

Although the terms such as first, second, and the like are used to describe various components, these components are not limited by these terms. These terms are used only to distinguish one component from another. Therefore, a first component mentioned below can be a second component within a technical idea of a present disclosure.

It will be understood that, although the terms such as “first,” “second,” “A,” “B,” “(a),” and “(b)”, etc., can be used herein to describe various elements, these elements should not be limited by these terms. These terms are only used to distinguish one element from another. For example, a first element could be termed a second element, and, similarly, a second element could be termed a first element, without departing from the scope of the present disclosure. Further, the term “can” fully encompasses all the meanings and coverages of the term “may” and vice versa.

Features of each of the various examples of the present disclosure can be partially or entirely coupled or combined with each other, technically various interworking and driving are possible, and each of the examples can be independently implemented with respect to each other or can be implemented together in a related relationship.

Hereinafter, embodiments of the present disclosure will be described in detail with reference to the accompanying drawings. All the components of each display device/apparatus according to all embodiments of the present disclosure are operatively coupled and configured.

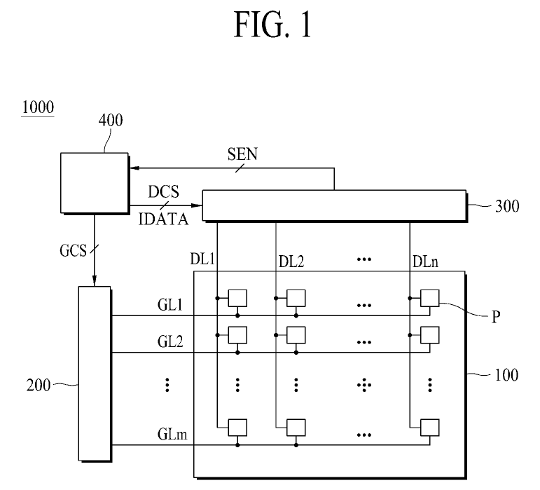

FIG. 1 is a block diagram of a display device 1000 according to an embodiment of the present disclosure.

Referring to FIG. 1, the display device 1000 can include a display panel 100, a gate driver 200, a data driver 300, and a timing controller 400. Hereinafter, a case in which the display device according to the present disclosure is an organic light emitting display device will be described.

The display panel 100 can include a display area for displaying an image and a non-display area disposed outside the display area. A plurality of gate lines GL1 to GLm (where m is a natural number greater than 1) and a plurality of data lines DL1 to DLn (where n is a natural number greater than 1) can be disposed in the display area. The plurality of gate lines GL and the plurality of data lines DL can intersect with each other.

A plurality of pixels P can be disposed in an area where the plurality of gate lines GL and the plurality of data lines DL cross each other. For example, the plurality of pixels P can be arranged in a matrix form including a plurality of rows and columns. In addition, each of a plurality of pixels P can receive a scan signal through the plurality of gate lines GL and a data signal through the plurality of data lines DL.

The gate driver 200 can receive a gate driver control signal GCS from the timing controller 400. The gate driver 200 can supply a scan signal to the gate line GL according to the gate driver control signal GCS. In addition, the gate driver 200 can be disposed in a non-display area on one side or both sides of the display area of the display panel 100 using a GIP (gate driver in panel) scheme, but is not limited thereto.

The data driver 300 can receive a data driver control signal DCS and an image data IDATA from the timing controller 200. The data driver 300 can convert the image data IDATA into a data voltage according to the data driver control signal DCS, and can supply the data voltage to the data line DL.

The timing controller 200 can control operation timings of the gate driver 200 and the data driver 300. The timing controller 200 can generate a gate driver control signal GCS, a data driver control signal DCS, and image data IDATA according to a timing signal received from a host system.

The timing controller 200 can supply the gate driver control signal GCS to the gate driver 200, and supply the data driver control signal DCS and the image data IDATA to the data driver 300.

The timing controller 200 can receive a sensing data SEN from the data driver 300. The sensing data SEN can be generated by using a temperature data and a voltage data of the data driver 300. The timing controller 200 can set the data driver control signal DCS and image data IDATA to be supplied to the data driver 300 through the sensing data SEN. The temperature data and the voltage data of the data driver 300 will be described in detail later.

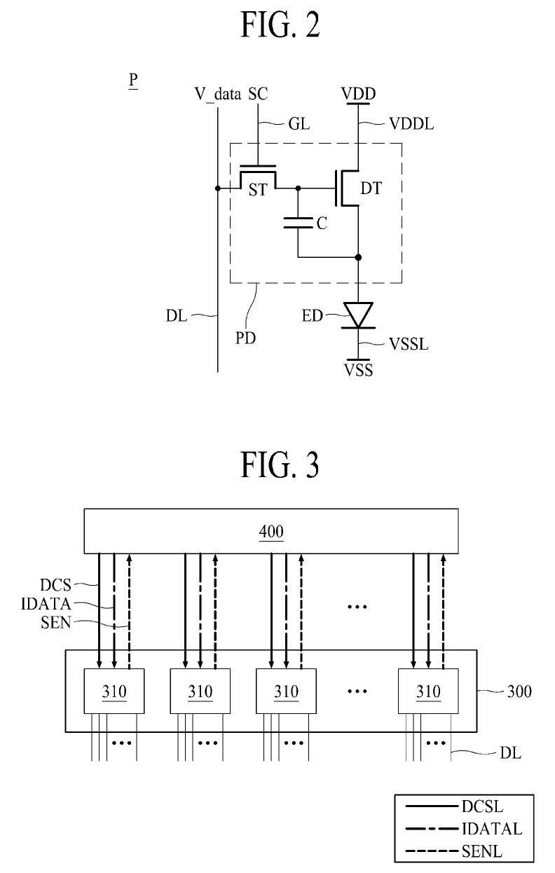

FIG. 2 is a diagram illustrating an example of a circuit diagram of a pixel P of FIG. 1.

As described above, the display panel 100 can include a plurality of pixels P. The plurality of pixels P can be arranged in a matrix form including a plurality of rows and columns. FIG. 2 shows a circuit diagram of any one pixel P.

Referring to FIG. 2, one pixel P can include a pixel driver PD and a light emitting device ED. The pixel driver PD can be a circuit for driving the light emitting device ED. In addition , the pixel driver PD can include a driving transistor DT, a switching transistor ST, and a capacitor C.

The driving transistor DT can be disposed between a high potential voltage line VDDL and the light emitting device ED. The driving transistor DT can adjust a current flowing from the high potential voltage line VDDL to the light emitting device ED according to the voltage difference between a gate electrode and a source electrode.

A gate electrode of the driving transistor DT can be connected to a first electrode of the switching transistor ST, the first electrode (source electrode or drain electrode) of the driving transistor DT can be connected to an anode of the light emitting device ED, and a second electrode (drain electrode or source electrode) of the driving transistor DT can be connected to the high potential voltage line VDDL to which the high potential voltage VDD is supplied.

The switching transistor ST can be driven by a scan signal SC of the gate line GL. When the switching transistor ST is turned on by the scan signal SC, the switching transistor ST can supply a data voltage V_data of the data line DL to the gate electrode of the driving transistor DT. In addition, a gate electrode of the switching transistor ST can be connected to the gate line GL, a first electrode of the switching transistor ST can be connected to the gate electrode of the driving transistor DT, and a second electrode of the switching transistor ST can be connected to the data line DL.

The capacitor C can be disposed between the gate electrode and the source electrode of the driving transistor DT. The capacitor C can store a difference voltage between the gate voltage and the source voltage of the driving transistor DT.

FIG. 2 illustrates that the driving transistor DT and the switching transistor ST are formed of an N-type metal oxide semiconductor field effect transistor (MOSFET), but is not limited thereto. For example, the driving transistor DT and the switching transistor ST can be P-type MOSFET. In addition, the first electrode can be a source electrode and the second electrode can be a drain electrode, but is not limited thereto. For example, the first electrode can be a drain electrode, and the second electrode can be a source electrode.

The light emitting device ED can emit light according to the current supplied through the driving transistor DT. An anode of the light emitting device ED can be connected to the source electrode of the driving transistor DT, and a cathode of the light emitting device ED can be connected to a low potential voltage line VSSL to which a low potential voltage VSS is supplied. The low potential voltage VSS can be a voltage lower than the high potential voltage ELVDD.

When the light emitting device ED is an organic light emitting diode (OLED), the light emitting device ED can include an anode, a hole transporting layer, an emitting layer, an electron transporting layer, and a cathode. When a voltage is applied to the anode and the cathode by the pixel driver PD, holes and electrons move to the emitting layer through the hole transport layer and the electron transport layer, respectively, and holes and electrons can be combined with each other in the emitting layer. Accordingly, the light emitting device ED can emit light.

FIG. 3 is a block diagram of the data driver 300 and the timing controller 400 according to an embodiment of the present disclosure.

Referring to FIG. 3, the data driver 300 can include at least one data drive IC 310.

The data drive IC 310 can receive the data driving control signal DCS and the image data IDATA from the timing controller 400 and can generate a data voltage V_data corresponding to the image data IDATA. The data drive IC 310 can supply the data voltage V_data to the display panel 100.

When the data driver 300 includes one data drive IC 310, the data drive IC 310 can be the same as the data driver 300. In this case, all of the plurality of data lines DL can be connected to one data drive IC 310. Alternatively, when the data driver 300 includes a plurality of data drive ICs 310, the plurality of data lines DL can be grouped, and each data line group can be connected to the corresponding data drive IC 310.

The timing controller 400 can be connected to the data drive IC 310 through a data driver control signal line DCSL. For example, the timing controller 410 can supply a data driver control signal DCS corresponding to each data drive IC 310 through the data driver control signal line DCSL. For example, a method in which the timing controller 400 is connected to the data drive IC 310 through the data driver control signal line DCSL can be a point-to-point method.

The timing controller 400 can be connected to the data drive IC 310 through an image data line IDATAL. The timing controller 400 can supply an image data IDATA corresponding to each of the data drive IC 310 through the image data line IDATAL. For example, a method in which the timing controller 400 is connected to the data drive IC 310 through the image data line IDATAL can be a point-to-point method.

The timing controller 400 can be connected to the data drive IC 310 through a sensing data line SENL. For example, the timing controller 410 can receive a sensing data SEN corresponding to each of the data drive IC 310 through the sensing data line SENL. For example, a method in which the timing controller 400 is connected to the data drive IC 310 through the sensing data line SENL can be a point-to-point method.

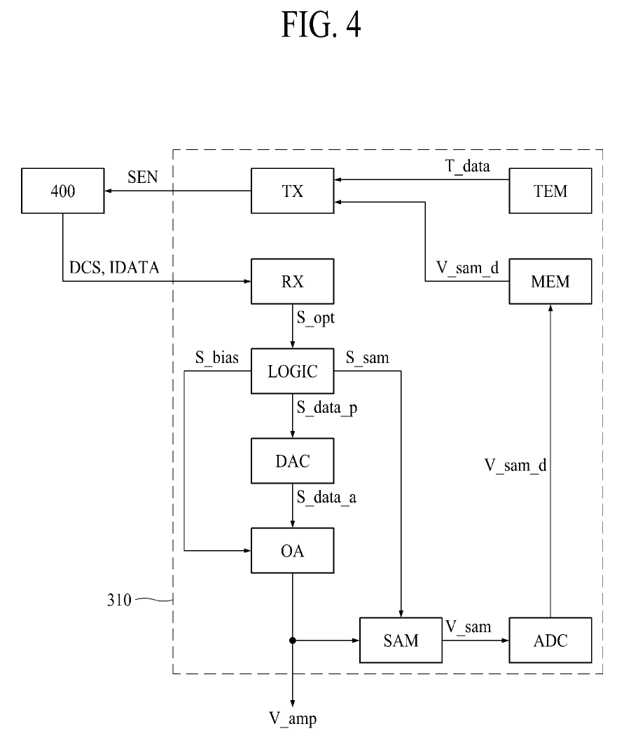

FIG. 4 is a block diagram of a data drive IC 310 according to an embodiment of the present disclosure.

As described above, the timing controller 400 can supply the data driver control signal DCS and the image data IDATA to the data drive IC 310, and the data drive IC 310 can supply the sensing data SEN to the timing controller 400.

Referring to FIG. 4, the data drive IC 310 can include a receiving unit RX, a logic unit LOGIC, a digital-to-analog converter DAC, an output amplifier unit OA, a sampling unit SAM, an analog-to-digital converter ADC, a memory unit MEM, a temperature sensor TEM, and a transmitting unit TX.

The receiving unit RX can receive the data driver control signal DCS and the image data IDATA from the timing controller 400. The receiving unit RX can optimize the data driver control signal DCS and the image data IDATA in a format that the data drive IC 310 can process. In this case, the optimized data driver control signal DCS and the optimized image data IDATA by the receiving unit RX can be referred to as an optimization signal S_opt. For example, the receiving unit RX can receive the data driver control signal DCS and the image data IDATA and output the optimization signal S_opt. The receiving unit RX can supply the optimization signal S_opt to the logic unit LOGIC.

The logic unit LOGIC can receive the optimization signal S_opt from the receiving unit RX. The optimization signal S_opt can include a serial data signal S_data_s, a bias control signal S_bias, and a sampling unit control signal S_sam. The serial data signal S_data_s can be optimized image data IDATA. In addition, the bias control signal S_bias is a signal for controlling a driving of the output amplifier unit OA, and the sampling unit control signal S_sam can be a signal for controlling a driving of the sampling unit SAM.

The logic unit LOGIC can supply different signals to each of the digital-to-analog converter DAC, the output amplifier unit OA, and the sampling unit SAM.

The logic unit LOGIC can convert the serial data signal S_data_s into a parallel data signal S_data_p. In addition , the logic unit LOGIC can supply the parallel data signal S_data_p to the digital-to-analog converter DAC. As the logic unit LOGIC converts the serial data signal S_data_s into the parallel data signal S_data, the logic unit LOGIC can simultaneously apply a data signal to the digital-to-analog converter DAC.

The logic unit LOGIC can supply the bias control signal S_bias to the output amplifier unit OA. In addition, the logic unit LOGIC can supply the sampling unit control signal S_sam to the sampling unit SAM.

The digital-to-analog converter DAC can receive the parallel data signal S_data_p from the logic unit LOGIC. The parallel data signal S_data_p can be a digital signal. Accordingly, the digital-to-analog converter DAC can convert the parallel data signal S_data_p into an analog signal. In this case, the parallel data signal S_data_p converted into an analog signal can be referred to as an analog data signal S_data_a. For example, the digital-to-analog converter DAC can receive the parallel data signal S_data_p and output an analog data signal S_data_a. The digital-to-analog converter DAC can supply the analog data signal S_data_a to the output amplifier unit OA.

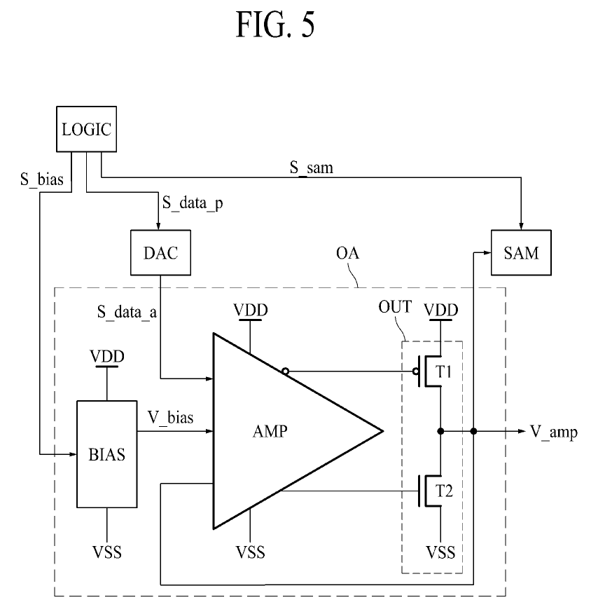

The output amplifier unit OA can receive the bias control signal S_bias from the logic unit LOGIC and can receive the analog data signal S_data_a from the digital-to-analog converter DAC. The output amplifier unit OA can generate an amp voltage V_amp through the bias control signal S_bias and the analog data signal S_data_a. The amp voltage V_amp becomes an output voltage of the data drive IC 310, and the amp voltage V_amp can be used as a data voltage V_data. In addition, the output amplifier unit OA can transmit the amp voltage V_amp to the sampling unit SAM. Meanwhile, a driving process of the output amp OA will be described in detail with reference to FIG. 5.

The sampling unit SAM can receive the amp voltage V_amp from the output amplifier unit OA, and can receive the sampling unit control signal S_sam from the logic unit LOGIC. The sampling unit SAM can sample the amp voltage V_amp according to the sampling unit control signal S_sam.

Specifically, when the sampling unit SAM is turned on by the sampling unit control signal S_sam, the sampling unit SAM can measure the amp voltage V_amp at a specific time point. In this case, the amp voltage V_amp sampled by the sampling unit SAM can be referred to as a sampling voltage V_sam. For example, the sampling unit SAM can receive the amp voltage V_amp and the sampling unit control signal S_sam, and output the sampling voltage V_sam. In addition, the sampling unit SAM can supply the sampling voltage V_sam to the analog-to-digital converter ADC.

The analog-to-digital converter ADC can convert the sampling voltage V_sam that is an analog signal into a digital sampling voltage V_sam_d that is a digital signal. The analog-to-digital converter ADC can supply the digital sampling voltage V_sam_d to the memory unit MEM.

The memory unit MEM can receive the digital sampling voltage V_sam_d from the analog-to-digital converter ADC. While the temperature sensor TEM generates the temperature data T_data, the memory unit MEM can store a value of the digital sampling voltage V_sam_d. The memory unit MEM can supply the digital sampling voltage V_sam_d to the transmitting unit TX.

The temperature sensor TEM can measure a temperature inside the data drive IC 310 and in an area adjacent to the data drive IC 310. Then, temperature data T_data can be generated by using a measured temperature. The temperature sensor TEM can supply the temperature data T_data to the transmitting unit TX.

The transmitting unit TX can receive the digital sampling voltage V_sam_d from the memory unit MEM and the temperature data T_data from the temperature sensor TEM. The transmitting unit TX can convert the digital sampling voltage V_sam_d and the temperature data T_data in a format that the timing controller 400 can process. In this case, the digital sampling voltage V_sam_d and temperature data T_data converted by the transmitting unit TX can be referred to as sensing data SEN. For example, the transmitting unit TX can receive the digital sampling voltage V_sam_d and the temperature data T_data and output sensing data SEN. The transmitting unit TX can supply the sensing data SEN to the timing controller 400.

FIG. 5 is a circuit diagram of an output amplifier unit OA according to an embodiment of the present disclosure.

As described above, the output amplifier unit OA can receive the bias control signal S_bias from the logic unit LOGIC and the analog data signal S_data_a from the digital-to-analog converter DAC.

Referring to FIG. 5, the output amplifier unit OA can include a bias circuit BIAS, an amplifier AMP, and an output unit OUT.

The bias circuit BIAS can receive the bias control signal S_bias from the logic unit LOGIC. The bias circuit BIAS can output a bias voltage V_bias according to the bias control signal S_bias. For example, when a value of the bias control signal S_bias changes, a value of the bias voltage V_bias can change.

The amplifier AMP can receive the analog data signal S_data_a from the digital-to-analog converter DAC, and can receive the bias voltage V_bias from the bias circuit BIAS. According to the analog data signal S_data_a and the bias voltage V_bias, the amplifier AMP can generate an amplifier voltage V_amp. In addition, the amplifier AMP can be implemented as a differential amplifier or can include a differential amplifier.

Specifically, a first input terminal of the amplifier AMP can be connected to the analog data signal S_data_a, and a second input terminal of the amplifier AMP can be connected to the bias voltage V_bias, e.g., connected to the bias circuit BIAS to receive the bias voltage V-bias. In addition, the amplifier voltage V_amp can be output through an output terminal of the amplifier AMP.

In this case, according to the value of the bias voltage V_bias, a magnitude of the analog data signal S_data_a is amplified and can be outputted as an amp voltage V_amp. For example, the value of the bias voltage V_bias is determined by the bias control signal S_bias, and a slew rate of the amp voltage V_amp can be determined by the bias voltage V_bias.

The output unit OUT can receive the amp voltage V_amp from the amplifier AMP. The output unit OUT functions as a buffer and can stabilize the amp voltage V_amp. For example, the output unit OUT can minimize an influence of a load by the display panel 100 on the amplifier AMP. Accordingly, the amp voltage V_amp can be stably output from the output amplifier unit OA. In addition, the output unit OUT can transmit the amp voltage V_amp to the sampling unit SAM.

The output unit OUT can include a first transistor T1 and a second transistor T2. The first transistor T1 and the second transistor T2 can be connected in series. In addition, a gate electrode of the first transistor T1 and a gate electrode of the second transistor T2 can be connected to the amp voltage V_amp. The gate electrode of the first transistor T1 can be connected to the amplifier AMP, a first electrode of the first transistor T1 can be connected to a high potential voltage VDD, and a second electrode of the first transistor T1 can be connected to the second transistor T2. In addition, a gate electrode of the second transistor T2 can be connected to the amplifier AMP, a first electrode of the second transistor T2 can be connected to the first transistor T1, and a second electrode of the second transistor T2 can be connected to a low potential voltage VSS.

FIG. 5 shows that the first transistor T1 is a P-type MOSFET and the second transistor T2 is formed of an N-type MOSFET, but is not limited thereto.

In addition , in FIG. 5, a circuit of the output unit OUT is configured through the first transistor T1 and the second transistor T2, but is not limited thereto. For example, the output unit OUT can include a buffer circuit further using an additional transistor in addition to the first transistor T1 and the second transistor T2.

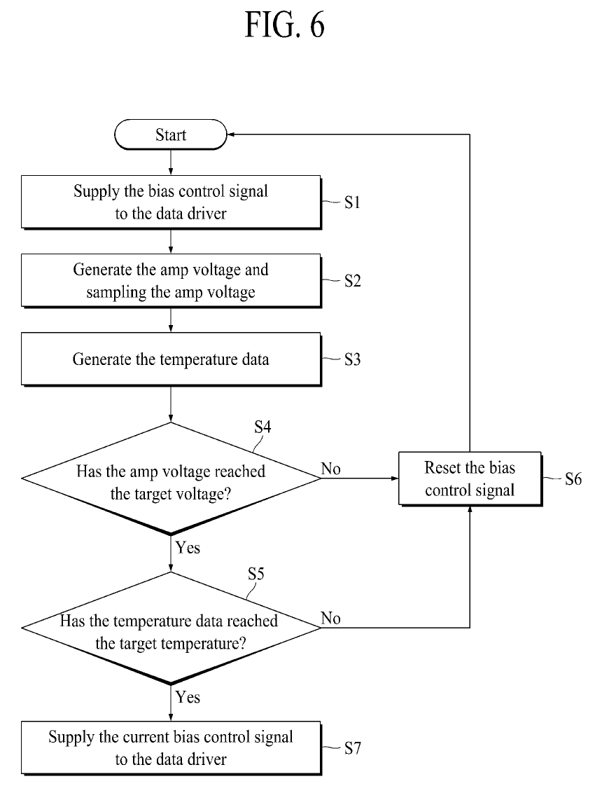

FIG. 6 is a flowchart illustrating a driving method of a display device according to an embodiment of the present disclosure.

The display device can be driven in units of frames including an initialization period, a sampling period, a programming period, and a light emission period. In one frame, the initialization period, the sampling period, the programming period, and the light emission period can be sequentially performed.

The initialization period can be a period for initializing various signals supplied to the display panel 100. Specifically, in the initialization period, the scan signal SC and the data voltage V_data described above with reference to FIG. 2 can be initialized.

The sampling period can be a period in which values of various signals supplied to the display panel 100 are set. Specifically, the sampling period can be a period in which a driving process of the data driver 300 described in FIGS. 4 and 5 is performed. For example, the amp voltage V_amp can be set in the sampling period.

The programming period can be a period for supplying a set signal to the display panel 100. In detail, the amp voltage V_amp set in the sampling period is supplied to the data line DL, and the amplifier voltage V_amp can function as a data voltage V_data.

The light emitting period can be a period in which the display panel 100 displays an image. Specifically, the light emitting device ED described above with reference to FIG. 2 can emit light during the light emitting period.

Accordingly, FIG. 6 illustrates a method of driving the data driver 300 and the timing controller 400 in a sampling period.

Referring to FIG. 6, in a first step S1, a bias control signal S_bias can be supplied to the data driver 300.

For example, as described above in FIGS. 4 and 5, the data driver 300 can receive the bias control signal S_bias based on the data driver control signal DCS of the timing controller 400. The timing controller 400 can set the bias control signal S_bias so that a power used in the output amplifier unit OA of the data driver 300 has a minimum value. For example, the bias control signal S_bias can determine a magnitude of the bias voltage V_bias output from the bias circuit BIAS and provided to the amplifier AMP. For example, the bias voltage V_bias can be set so that a minimum value of the power used in the output amplifier unit OA is 1.5 W.

In a second step S2, the data driver 300 can generate an amp voltage V_amp and sample the amp voltage V_amp.

For example, as described above in FIGS. 4 and 5, the output amplifier unit OA of the data driver 300 can generate the amp voltage V_amp based on the bias control signal S_bias and the analog data signal S_data_a. In particular, since power used in the output amplifier unit OA is determined according to the bias control signal S_bias, a slew rate of the amp voltage V_amp can be determined according to the bias control signal S_bias. The sampling unit SAM can sample the generated amp voltage V_amp. Specifically, when the sampling unit SAM is turned on by the sampling unit control signal S_sam, the sampling unit SAM can measure the amp voltage V_amp at a specific time point.

In a third step S3, the temperature sensor TEM can generate a temperature data T_data. Specifically, the temperature sensor TEM can measure the temperature inside the data drive IC 310 and in an area adjacent to the data drive IC 310. Further, the temperature sensor TEM can generate the temperature data T_data by using a measured temperature.

In a fourth step S4, it can be determined whether the amp voltage V_amp reaches a target voltage V_target.

In detail, the timing controller 400 can compare the sampled amp voltage V_amp with the target voltage V_target. The target voltage V_target can be a voltage value preset in the timing controller 400. In particular, the target voltage V_target can be an optimal voltage value for driving the display panel 100 connected to the data driver 300. When the digital sampling voltage V_sam_d does not reach the target voltage V_target, the display panel 100 may not be stably driven, and a quality of the display panel 100 can be deteriorated.

The target voltage V_target can have different values according to physical conditions of the display panel 100. For example, the target voltage V_target can have different values according to a size of the display panel 100.

When the amp voltage V_amp reaches the target voltage V_target, a fifth step S5 can be entered.

In the fifth step S5, it can be determined whether the temperature data T_data reaches a target temperature T_target.

In detail, the timing controller 400 can compare the temperature data T_data with the target temperature T_target. The target temperature T_target can be a temperature value preset in the timing controller 400. In particular, the target temperature T_target can be an optimal temperature value for driving the display panel 100 connected to the data driver 300. When the temperature data T_data does not reach the target temperature T_target, the display panel 100 may not be stably driven, and the quality of the display panel 100 can be deteriorated,

The target temperature T_target can have different values according to physical conditions of the display panel 100. For example, the target temperature T_target can have different values according to the size of the display panel 100 or an electric element constituting the display panel 100. Alternatively, the target temperature T_target can have different values according to physical conditions of the data driver 300. For example, the target temperature T_target can have different values according to the guaranteed temperature of the data drive IC 310 of the data driver 300.

When the temperature data T_data reaches the target temperature T_target, the timing controller 400 can supply the current data driver control signal DCS to the data driver 300. For example, the data driver 300 can receive the current bias control signal S_bias. Accordingly, the data driver 300 can maintain the current amp voltage V_amp and the current temperature data T_data.

On the other hand, in the fourth step S4, if the amp voltage V_amp does not reach the target voltage V_target, a sixth step S6 can be entered. Alternatively, in the fourth step S4, even if the amp voltage V_amp reaches the target voltage V_target, in the fifth step S5, if the temperature data T_data does not reach the target temperature T_target, the sixth step S6 can be entered.

In the sixth step S6, the timing controller 400 can reset the data driver control signal DCS. Since the data driver control signal DCS is reset, the bias control signal S_bias generated based on the data driver control signal DCS can also be reset.

For example, the bias control signal S_bias can be reset so that the bias voltage V_bias increases. For example, the timing controller 400 can reset the bias control signal S_bias so that an output of the output amplifier unit OA increases gradually. For example, the timing controller 400 can reset the bias control signal S_bias so that the output of the output amplifier unit OA increases by 0.03 W from the original output value, but is not limited thereto.

When the sixth step S6 is over, the first step S1 can be entered again. For example, the reset bias control signal S_bias can be supplied to the data driver 300. In the second step S2, the data driver 300 is driven according to the reset bias control signal S_bias, and the output amplifier unit OA can generate a new amp voltage V_amp. In the third step S3, the temperature sensor TEM can also generate new temperature data T_data according to the new amp voltage V_amp.

When the new amp voltage V_amp reaches the target voltage V_target and the new temperature data T_data reaches the target temperature T_target, the timing controller 400 can supply the current data driver control signal DCS to the data driver 300. That is, as shown in a step S7, given that condition, the data driver 300 can receive the current bias control signal S_bias. Accordingly, the data driver 300 can maintain the current amp voltage V_amp and the current temperature data T_data.

On the other hand, when the new amp voltage V_amp does not reach the target voltage V_target, or the new temperature data T_data does not reach the target temperature T_target, the sixth step S6 can be entered again.

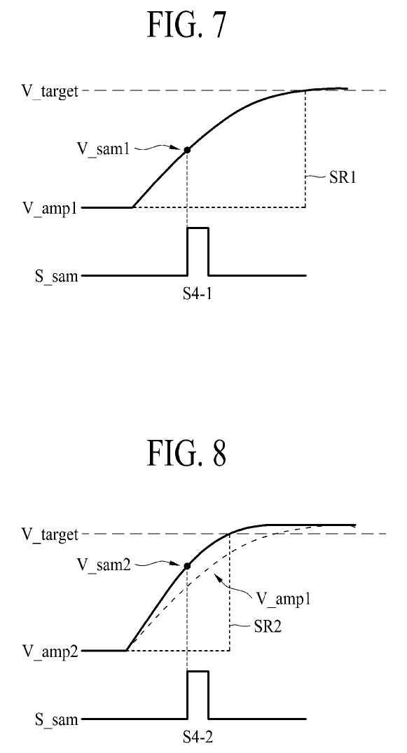

FIGS. 7 to 10B are example graphs of amp voltage and temperature data according to an embodiment of the present disclosure.

Particularly, FIGS. 7 to 10B do not illustrate a detailed simulation result or measurement value of the amp voltage V_amp and the temperature data T_data. FIGS. 7 to 10B illustrate a process in which the amp voltage V_amp and the temperature data T_data are changed according to a driving of the data driver 300 and the timing controller 400 described in FIG. 6 according to an example of the present disclosure.

As described above in FIG. 6, the data driver 300 can generate an amp voltage V_amp based on the bias control signal S_bias and the analog data signal S_data_a.

FIG. 7 illustrates a process of performing a first fourth step S4-1.

The amplifier AMP of the output amplifier unit OA has a first slew rate SR1 and can generate a first amp voltage V_amp1. When the sampling unit control signal S_sam is input to the sampling unit SAM, the sampling unit SAM can sample the first amp voltage V_amp1. The sampling unit SAM can generate a first sampling voltage V_sam1 by sampling the first amp voltage V_amp1.

In the first fourth step S4-1, the timing controller 400 can determine whether the first sampling voltage V_sam1 reaches a target voltage V_target. Referring to FIG. 7, when the first sampling voltage V_sam1 does not reach the target voltage V_target, the sixth step S6 can be entered. As described above, in the sixth step S6, the timing controller 400 can reset the data driver control signal DCS. Since the data driver control signal DCS is reset, the bias control signal S_bias generated based on the data driver control signal DCS can also be reset. The bias voltage V_bias supplied to the output amplifier unit OA of the data driver 300 can increase by the reset bias control signal S_bias. Meanwhile, the image data IDATA can be the same.

After performing the sixth step S6, the data driver 300 can perform the first step S1, the second step S2, and the third step S3 and enter a second fourth step S4-2. FIG. 8 illustrates a process of performing the second fourth step S4-2.

The amplifier AMP of the output amplifier unit OA can have a second slew rate SR2 and can generate a second amp voltage V_amp2. The second slew rate SR2 can be greater than the first slew rate SR1 by the reset bias control signal S_bias. Accordingly, the second amp voltage V_amp2 can be greater than the first amp voltage V_amp1. When the sampling unit control signal S_sam is input to the sampling unit SAM, the sampling unit SAM can sample the second amp voltage V_amp2. The sampling unit SAM can generate a second sampling voltage V_sam2 by sampling the second amp voltage V_amp2.

In the second and fourth step S4-2, the timing controller 400 can determine whether the second sampling voltage V_sam2 reaches the target voltage V_target. Referring to FIG. 8, when the second sampling voltage V_sam2 does not reach the target voltage V_target, the sixth step S6 can be entered. As described above, in the sixth step S6, the timing controller 400 can reset the data driver control signal DCS. Since the data driver control signal DCS is reset, the bias control signal S_bias generated based on the data driver control signal DCS can also be reset. The bias voltage V_bias supplied to the output amplifier unit OA of the data driver 300 can increase by the reset bias control signal S_bias. Meanwhile, the image data IDATA can be the same.

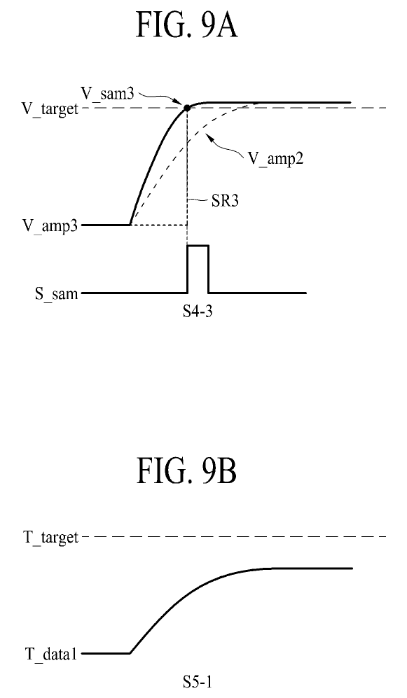

After performing the sixth step S6, the data driver 300 can perform the first step S1, the second step S2, and the third step S3 and enter a third fourth step S4-3. FIG. 9A illustrates the process of performing the third fourth step S4-3.

The amplifier AMP of the output amplifier unit OA has a third slew rate SR3 and can generate a third amp voltage V_amp3. The third slew rate SR3 can be greater than the second slew rate SR2 by the reset bias control signal S_bias. Accordingly, the third amp voltage V_amp3 can be greater than the second amp voltage V_amp2. When the sampling unit control signal S_sam is input to the sampling unit SAM, the sampling unit SAM can sample the third amp voltage V_amp3. The sampling unit SAM can generate a third sampling voltage V_sam3 by sampling the third amp voltage V_amp3.

In the third fourth step S4-3, the timing controller 400 can determine whether the third sampling voltage V_sam3 reaches the target voltage V_target. Referring to FIG. 9A, when the third sampling voltage V_sam3 reaches the target voltage V_target, the timing controller 400 can enter the fifth step S5 without entering the sixth step S6.

FIG. 9B illustrates a process of performing a first fifth step S5-1. In the first fifth step S5-1, the timing controller 400 can determine whether the first temperature data T_data1 reaches the target temperature T_target. Referring to FIG. 9B, when the first temperature data T_data does not reach the target temperature T_target, the sixth step S6 can be entered again. As described above, in the sixth step S6, the timing controller 400 can reset the data driver control signal DCS. Since the data driver control signal DCS is reset, the bias control signal S_bias generated based on the data driver control signal DCS can also be reset. By the reset bias control signal S_bias, the bias voltage V_bias supplied to the output amplifier unit OA of the data driver 300 can increase. Meanwhile, the image data IDATA can be the same.

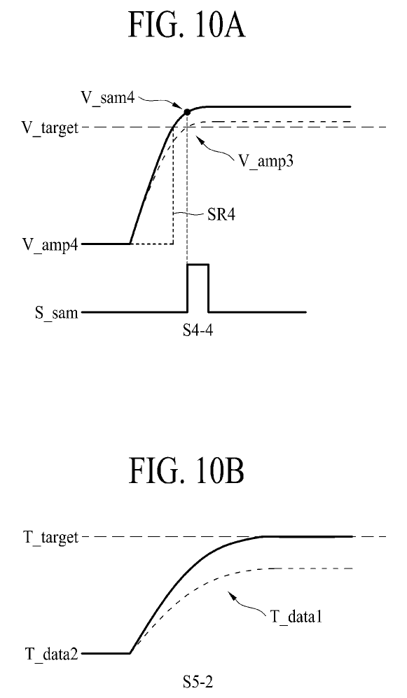

After performing the sixth step S6, the data driver 300 can perform the first step S1, the second step S2, and the third step S3 and enter a fourth fourth step S4-4. FIG. 10A illustrates the process of performing the fourth fourth step S4-4.

The amplifier AMP of the output amplifier unit OA has a fourth slew rate SR4 and can generate a fourth amp voltage V_amp4. The fourth slew rate SR4 can be greater than the third slew rate SR3 by the reset bias control signal S_bias. Accordingly, the fourth amp voltage V_amp4 can be greater than the third amp voltage V_amp3. When the sampling unit control signal S_sam is input to the sampling unit SAM, the sampling unit SAM can sample the fourth amp voltage V_amp4. The sampling unit SAM can generate a fourth sampling voltage V_sam4 by sampling the fourth amp voltage V_amp4.

In the fourth fourth step S4-4, the timing controller 400 can determine whether the fourth sampling voltage V_sam4 reaches the target voltage V_target. Referring to FIG. 10A, when the fourth sampling voltage V_sam4 reaches the target voltage V_target, a second fifth step S5-2 can be entered.

FIG. 10B illustrates a process of performing the second fifth step S5-2. In the second fifth step S5-2, the timing controller 400 can determine whether the second temperature data T_data2 reaches the target temperature T_target. By the reset bias control signal S_bias, a slew rate and an amp voltage V_amp of the amplifier AMP increase, and the second temperature data T_data2 can be greater than the first temperature data T_data1.

Referring to FIG. 10B, when the second temperature data T_data2 reaches the target temperature T_target, the timing controller 400 can supply the current data driver control signal DCS to the data driver 300. Accordingly, the data driver 300 can maintain the current amp voltage V_amp and the current temperature data T_data.

In conclusion, the timing controller 400 can reset the bias control signal S_bias until the amp voltage V_amp reaches the target voltage V_target and the temperature data T_data reaches the target temperature T_target. Accordingly, the timing controller 400 can reset the bias control signal S_bias and control the output amplifier unit OA of the data driver 300. Accordingly, an optimum value of the bias voltage V_bias is checked in the display device, and the bias voltage V_bias is automatically set to the optimum value, so that the data driver 300 can be stably driven.

Generally, a load of the display panel 100 can vary according to a physical condition of the display panel 100 to which the data driver 300 is connected. For example, the load of the display panel 100 can vary according to a size of the display panel 100.

In this case, a slew rate of the data driver 300 connected to the display panel 100 can be changed. In particular, a slew rate of the amplifier AMP of the output amplifier unit OA of the data driver 300 can be changed.

For example, when the amp voltage V_amp output from the data driver 300 functions as a data voltage V_data, a speed at which the display panel 100 outputs an image can be delayed in response to the data voltage V_data. Alternatively, the data voltage V_data input to the display panel 100 can be smaller than a voltage for driving the display panel 100. Accordingly, the display panel 100 may not be stably driven, and quality of the display panel 100 can be deteriorated.

Alternatively, even if the amp voltage V_amp output from the data driver 300 functions smoothly as the data voltage V_data, the temperature data T_data may not satisfy a certain condition. In this case, the data driver 300 may not be stably driven, and the quality of the display panel 100 can be deteriorated.

To improve this, it is needed to adjust the output of the output amplifier unit OA of the data driver 300 while directly checking a magnitude of the amp voltage V_amp of the data driver 300 and the temperature data T_data of the data driver 300.

However, in the present disclosure, the timing controller 400 can automatically reset the bias control signal S_bias until the amp voltage V_amp reaches the target voltage V_target and the temperature data T_data reaches the target temperature T_target. Accordingly, even if a physical condition of the display panel 1000 is changed, the timing controller 400 can automatically set the amp voltage V_amp to an optimal value and set the temperature data T_data to an optimal value.

Therefore, according to the physical condition of the display panel 1000, even if the data driver 300 is not set from the outside, the data driver 300 can be stably driven and the quality of the display panel 100 can be improved according to aspects of the present disclosure.

It will be apparent to those skilled in the art that the present disclosure described above is not limited by the above-described embodiments and the accompanying drawings and that various substitutions, modifications and variations can be made in the present disclosure without departing from the technical idea or scope of the disclosures. Consequently, the scope of the present disclosure is defined by the accompanying claims and it is intended that all variations or modifications derived from the meaning, scope and equivalent concept of the claims fall within the scope of the present disclosure

What is claimed is:

1. A display device comprising:
a display panel including a plurality of pixels;
a data driver configured to supply a data voltage to the display panel and generate a sampling voltage and a temperature data; and
a timing controller configured to supply a bias control signal and an image data to the data driver, and change the bias control signal based on the sampling voltage and the temperature data, and
wherein the data driver includes:
an output amplifier unit configured to generate an amp voltage based on the bias control signal and the image data;
a sampling unit configured to sample the amp voltage at a preset period and output the sampling voltage; and
a temperature sensor configured to measure a temperature of the data driver and generate the temperature data.

2. The display device of claim 1, wherein the timing controller adjusts the bias control signal to increase a bias voltage supplied to the output amplifier unit, when the sampling voltage is smaller than a preset target voltage.

3. The display device of claim 1, wherein the timing controller adjusts the bias control signal to increase a bias voltage supplied to the output amplifier unit, when the temperature data is smaller than a preset target temperature.

4. The display device of claim 1, wherein a bias voltage supplied to the output amplifier unit increases when the sampling voltage is lower than a preset target voltage or the temperature data is lower than a preset target temperature.

5. The display device of claim 1, wherein the data driver further includes:
a logic unit configured to convert a serial data signal provided from the timing controller into a parallel data signal; and
a digital-to-analog converter configured to convert the parallel data signal into an analog data signal.

6. The display device of claim 5, wherein the output amplifier unit further includes:
a bias circuit configured to output a bias voltage in response to the bias control signal;
an amplifier configured to generate the amp voltage based on the analog data signal and the bias voltage; and
an output unit configured to stabilize the amp voltage.

7. The display device of claim 6, wherein the amplifier further includes:
a first input terminal connected to the analog data signal;
a second input terminal connected to the bias circuit to receive the bias voltage; and
an output terminal configured to output the amp voltage and transmit the amp voltage to the output unit.

8. The display device of claim 6, wherein the output unit includes a first transistor and a second transistor, and
wherein a gate electrode of the first transistor and a gate electrode of the second transistor are connected to the amp voltage from the amplifier.

9. The display device of claim 8, wherein the first and second transistors are connected in series.

10. The display device of claim 8, wherein the first transistor is a P-type MOSFET and the second transistor is an N-type MOSFET.

11. The display device of claim 1, wherein the data driver further includes an analog-to-digital converter configured to convert the sampling voltage into a digital signal and output a digital sampling voltage.

12. The display device of claim 11, wherein the data driver further includes a memory unit configured to store the digital sampling voltage.

13. A driving method of a display device including a data driver, the driving method comprising:
generating an amp voltage through the data driver based on a bias voltage and an analog data signal, and sampling the amp voltage;
generating a temperature data by measuring a temperature of the data driver and/or an area around the data driver at a preset period;
determining whether the amp voltage has reached a target voltage at a sampling point of the amp voltage;
determining whether the temperature data has reached a target temperature; and
resetting a bias control signal configured to control a magnitude of the bias voltage according to a result of the determining whether the amp voltage has reached the target voltage and a result of the determining whether the temperature data has reached the target temperature.

14. The driving method of the display device of claim 13, wherein when the determining determines that the amp voltage has not reached the target voltage at the sampling point of the amp voltage, the resetting resets the bias control signal to be provided to the data driver.

15. The driving method of the display device of claim 14, wherein the bias voltage increases in response to the bias control signal that has been reset.

16. The driving method of the display device of claim 14, wherein when the determining determines that the temperature data has not reached the target temperature, the resetting resets the bias control signal to increase the bias voltage.

17. The driving method of the display device of claim 13, wherein when the determining determines that the amp voltage has reached the target voltage at the sampling point of the amp voltage and the determining determines that temperature data has reached the target temperature, the bias control signal corresponding to the bias voltage is supplied to the data driver.
